(19) United States
(12) Patent Application Publication
(10) Pub. No.: US 2016/0155528 A1
(43) Pub. Date: Jun. 2, 2016

(54) ELECTRICALLY CONDUCTIVE MATERIAL

(71) Applicant: Panasonic Intellectual Property Management Co., Ltd., Osaka (JP)

(72) Inventor: AKIHIKO TADAMASA, Osaka (JP)

(21) Appl. No.: 14/887,028

(22) Filed: Oct. 19, 2015

(30) Foreign Application Priority Data
Nov. 27, 2014 (JP) 2014-239849

(51) Int. Cl. H01B 1/04; H01B 1/06

(52) U.S. Cl. CPC H01B 1/04; H01B 1/06

(57) ABSTRACT

An electrically conductive material according to an embodiment of the present disclosure comprises: a graphite structure comprising graphene layers, the graphite structure having a first surface that is an outer surface of one of two outermost layers of the graphene layers, and a second surface that is an outer surface of the other of the two outermost layers of the graphene layers; and a metal chloride located between the graphene layers. The graphite structure has holes on the first surface, the holes passing through at least one of the graphene layers toward the second surface. A number of the holes per unit area on the first surface is one or more per 1 mm².

### BACKGROUND

1. Technical Field

The present disclosure relates to an electrically conductive material containing a graphite intercalation compound.

2. Description of the Related Art

Graphite is a hexagonal mineral which is composed of carbon and which has a flat hexagonal crystal structure. Graphite has a layered structure including stacked carbon monolayers (graphenes) in which carbon six-membered rings are two-dimensionally arranged. In the plane of each monolayer in graphite, carbon atoms are bonded to each other by strong covalent bonds. However, the monolayers are linked to each other by weak Van der Waals force. Therefore, graphite has high thermal conductivity in an in-plane direction and low thermal conductivity in an interplane direction. In the present disclosure, the two-dimensional direction in which graphenes making up graphite extend is referred to as the in-plane direction of graphite and the stacking direction of graphenes is referred to as an interplane direction in some cases. The term “layer in graphite” refers to graphene. The terms “between layers” and “interlayer” refer to “between graphenes”. In a crystal of graphite, the plane in which carbon six-membered rings are two-dimensionally arranged is hereinafter referred to as a crystal plane in some cases. The area of a crystal plane is referred to as a crystal area in some cases.

Graphite serves as a host and can form various graphite intercalation compounds (GICs) by intercalating various chemical species (guest substances) between layers therein. A graphite intercalation compound has lower electrical resistance due to the presence of a guest substance as compared to graphite, which is a host, and physical and chemical properties different from those of graphite (see, for example, Japanese Unexamined Patent Application Publication No. 61-168513).

For example, in a graphite intercalation compound containing graphite and an ionic chemical species intercalated therein, charge transfer occurs between the chemical species and graphite, whereby an electrical property of the graphite intercalation compound, that is, the band structure thereof is varied. This phenomenon is similar to a phenomenon in which the doping of a silicon semiconductor varies the band structure thereof.

### SUMMARY

One non-limiting and exemplary embodiment provides an electrically conductive material, excellent in electrical conductivity, containing a graphite intercalation compound.

In one general aspect, the techniques disclosed here feature an electrically conductive material. The electrically conductive material comprises: a graphite structure comprising graphene layers, the graphite structure having a first surface that is an outer surface of one of two outermost layers of the graphene layers, and a second surface that is an outer surface of the other of the two outermost layers of the graphene layers; and a metal chloride located between the graphene layers. The graphite structure has holes on the first surface, the holes passing through at least one of the graphene layers toward the second surface. A number of the holes per unit area on the first surface is one or more per 1 mm².

It should be noted that general or specific embodiments may be implemented as an element, a device, a system, an integrated circuit, a method, or any selective combination thereof.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1 is a sectional view of an electrically conductive material according to an embodiment of the present disclosure;

FIG. 2 is a sectional view of an electrically conductive material according to another embodiment of the present disclosure; and

FIG. 3 is a sectional view of graphite.

### DETAILED DESCRIPTION

A graphite intercalation compound disclosed in Rika Matsumoto, Yutaro Hoshina, and Noboru Akuzawa, “Thermoelectric Properties and Electrical Transport of Graphite Intercalation Compounds”, Materials Transactions, The Japan Institute of Metals and Materials, 2009, vol. 50, No. 7, p. 1607-1611 exhibits excellent electrical conductivity and thermal conductivity. However, the electrical conductivity of the graphite intercalation compound is not equivalent to that of metal. If a larger amount of a chemical species can be more uniformly introduced into graphite, then a graphite intercalation compound with higher electrical conductivity may possibly be obtained.

An aspect of the present disclosure is as summarized below.

### [Item 1]

An electrically conductive material comprises: a graphite structure comprising graphene layers, the graphite structure having a first surface that is an outer surface of one of two outermost layers of the graphene layers, and a second surface that is an outer surface of the other of the two outermost layers of the graphene layers; and a metal chloride located between the graphene layers. The graphite structure has holes on the first surface, the holes passing through at least one of the graphene layers toward the second surface. A number of the holes per unit area on the first surface is one or more per 1 mm². According to this configuration, the electrically conductive material can be provided so as to contain a graphite intercalation compound in which a sufficient amount of a chemical species is intercalated in a crystal regardless of the crystal size of the graphite used. Furthermore, according to this configuration, a sufficient amount of a chemical species is intercalated in a crystal even when the graphite, which is a host, has a large crystal size. Thus, the electrically conductive material can be provided so as to contain a graphite intercalation compound which has high electrical conductivity in such a state that, for example, the thermal conductivity of the graphite is maintained to a certain extent.

### [Item 2]

In the electrically conductive material specified in Item 1, the metal chloride includes at least one selected from the group consisting of iron chloride, copper chloride, nickel chloride, aluminium chloride, zinc chloride, cobalt chloride, gold chloride, and bismuth chloride. According to this configuration, the electrically conductive material can be provided so as to have high electrical conductivity.

### [Item 3]

In the electrically conductive material specified in Item 1 or 2, the number of the holes per unit area on the first surface is one or more per 0.1 mm². Forming the holes under this condition enables the intercalation of a chemical species in a crystal to be enhanced.

### [Item 4]

In the electrically conductive material specified in Item 3, the number of the holes per unit area on the first surface is one or more per 0.01 mm². Forming the holes under this condition enables the intercalation of a chemical species in a crystal to be enhanced.

### [Item 5]

In the electrically conductive material specified in any one of Items 1 to 4, at least one of the holes passes through the graphene layers from the first surface to the second surface.

### [Item 6]

The electrically conductive material specified in any one of Items 1 to 5 has an electrical conductivity of 100 kS/cm or more.

### [Item 7]

The electrically conductive material specified in any one of Items 1 to 6 has a thermal conductivity of 800 W/(m·K) or more.

### [Item 8]

In the electrically conductive material specified in any one of Items 1 to 7, the total area of the holes per unit area on the first surface is 0.1 cm² or less per 1 cm².

### [Item 9]

In the electrically conductive material specified in any one of Items 1 to 8, the holes each have a diameter of 1 nm or more and 500 μm or less.

### [Item 10]

A method for producing an electrically conductive material includes preparing graphite structure having a layered structure, forming holes in the graphite structure such that the holes are open to a surface (A) of the graphite structure and extend in a stacking direction of the graphite structure and the number of the holes per unit area (1 mm²) on the surface (A) is not less than a predetermined value, and intercalating a chemical species between layers in the graphite structure having the holes. An electrically conductive material according to the present disclosure is efficiently produced by the method.

The present disclosure is further described below in detail with reference to the accompanying drawings. The present disclosure is not limited to embodiments below.

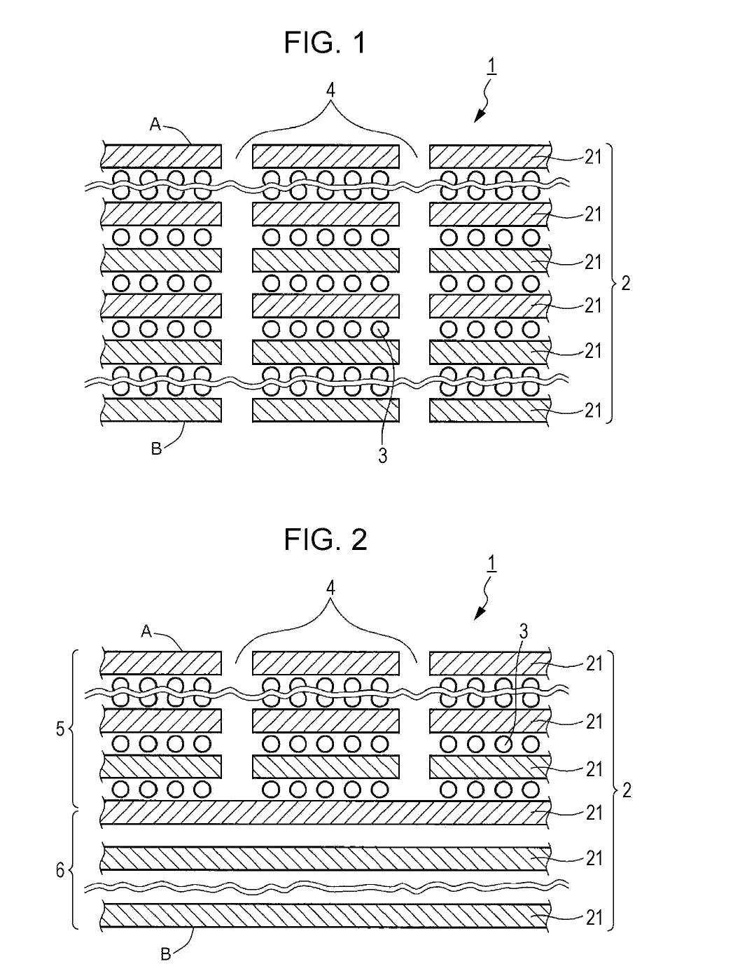

FIG. 1 shows an electrically conductive material 1 according to an embodiment. The electrically conductive material 1 contains graphite 2 having a layered structure and a chemical species 3 intercalated between layers in the graphite 2. The graphite 2 includes a stack of graphenes 21. The electrically conductive material 1 has holes 4. The holes 4 are open to a surface (A) of the electrically conductive material 1 and extend in a stacking direction of the graphite 2 (in other words, a stacking direction of the graphenes 21). Herein, the term “stacking direction” refers to a direction crossing a two-dimensional direction in which the graphenes 21 extend and is not limited to a direction normal to each graphene 21.

The holes 4 are arranged such that the number of the holes 4 per unit area (1 mm²) on the surface (A) is not less than a predetermined value. The number of the holes 4 may be sufficient to intercalate the chemical species 3 between the layers in the graphite 2. However, the holes 4 can be regarded as crystal defects. Therefore, when the number of the holes 4 is excessively large, the number of apparent crystal defects is large; hence, conductive properties (thermal conductivity and electrical conductivity) may possibly be reduced. In consideration of the ease of intercalating the chemical species 3, the number of the holes 4 per unit area (1 mm²) on the surface (A) is desirably one or more. If the holes 4 are formed under the above condition, then the electrically conductive material 1 can be obtained such that a sufficient amount of the chemical species 3 is intercalated in the electrically conductive material 1.

The number of the holes 4 per unit area (0.1 mm²) on the surface (A) is desirably one or more. The number of the holes 4 per unit area (0.01 mm²) on the surface (A) is more desirably one or more. The total area of the holes 4 per unit area on the surface (A) is desirably 0.1 cm² or less per 1 cm².

The diameter of each hole 4 is not particularly limited. The diameter of the hole 4 may be sufficient to intercalate the chemical species 3. As the diameter of the hole 4 is large, conductive properties are low. The diameter of the hole 4 is, for example, 1 nm to 500 μm.

The holes 4 may include through-holes open to a surface (B) opposite to the surface (A) of the electrically conductive material 1 as shown in FIG. 1 or may include blind concave holes (not open to the surface (B)) as shown in FIG. 2. A first surface is exemplified by the surface (A) and a second surface is exemplified by the surface (B), in this embodiment.

The depth of each concave hole is desirably 50% or more of the thickness of the electrically conductive material 1. The concave holes allow regions containing different amounts of the intercalated chemical species 3 to be formed in the electrically conductive material 1. In the case where the concave holes are formed on, for example, the surface (A) of the electrically conductive material 1 as shown in FIG. 2, the chemical species 3 is sufficiently intercalated between the layers from the surface (A) to the bottom of each hole 4. Therefore, this portion corresponds to a portion 5 in which properties induced by the intercalation of the chemical species 3 are high. On the other hand, a portion 6 in which the properties induced by the intercalation of the chemical species 3 are low is present between the layers from the bottom of the hole 4 to the surface (B), which is opposite to the surface (A). When one of the properties induced by the intercalation of the chemical species 3 is electrical conductivity, the portion 5 is a high-electrical conductivity portion with a large electrical conductivity and the portion 6 is a low-electrical conductivity portion with a small electrical conductivity.

In this embodiment, the holes 4 extend perpendicularly to the plane of each graphene 21. However, the direction in which the holes 4 extend is not limited to a direction perpendicular to the plane of the graphene 21. The holes 4 may extend from the surface (A) toward the surface (B) and need not extend perpendicularly to the plane of the graphene 21.

The graphite 2 may be a known one. The graphite 2 is desirably, for example, a pyrolytic graphite sheet, obtained by heat-treating a polyimide film at a temperature of 2,600° C. to 3,000° C., containing large graphite grains.

The chemical species 3, which is intercalated in the graphite 2, is a metal chloride or a metal obtained by reducing the metal chloride. The metal chloride may be, for example, at least one selected from the group consisting of iron chloride, copper chloride, nickel chloride, aluminium chloride, zinc chloride, cobalt chloride, gold chloride, and bismuth chloride. Two or more of these chlorides may be used in combination. The metal chloride may be reduced into fine metal particles in such a manner that the electrically conductive material 1 intercalated with the metal chloride is treated at a temperature of 250° C. to 500° C. in the presence of a 5% to 100% hydrogen stream. In the present disclosure, the chemical species 3 functions as an acceptor providing positive holes to the graphenes 21. Intercalating the chemical species 3 in the graphite 2 varies properties, such as electrical conductivity, optical properties, and magnetic properties, of the graphite 2.

In this embodiment, the electrically conductive material 1 has an electrical conductivity of 100 kS/cm² or more and a thermal conductivity of 800 W/(m·K) or more.

An exemplary method for producing the electrically conductive material 1 according to this embodiment is described below.

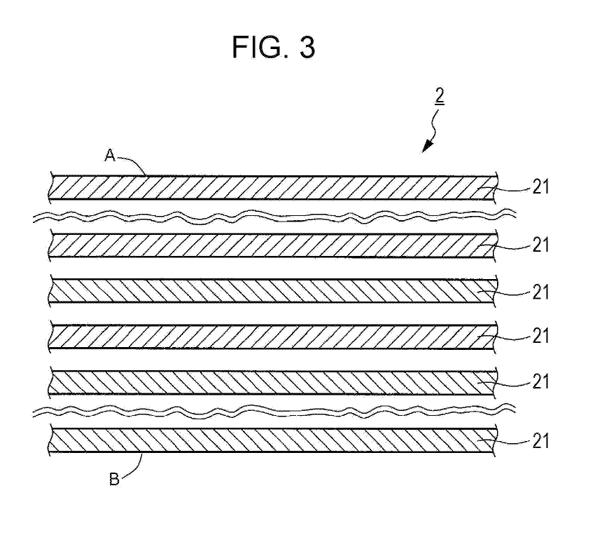

In the method, the graphite 2 is prepared. FIG. 3 shows the graphite 2, which is a source material for the electrically conductive material 1 shown in FIGS. 1 and 2. The graphite 2 has a layered structure in which the graphenes 21 are stacked.

Holes are formed in the graphite 2 such that the holes are open to a surface (A) of the graphite 2 and extend in a stacking direction of the graphenes 21 and the number of the holes per unit area (1 mm²) on the surface (A) is not less than a predetermined value. The holes correspond to the holes 4 in the electrically conductive material 1. Thus, the number, shape, and the like of the holes are as described for the holes 4 and therefore are not described in detail.

A known method can be used to form the holes on the surface (A) of the graphite 2. The holes can be formed as desired using, for example, a laser having appropriate wavelength, power, and the like.

A chemical species is intercalated between layers in the graphite 2 having the holes. The intercalated chemical species is the chemical species 3 intercalated in the electrically conductive material 1 described above and therefore is not described in detail.

A known method can be used to intercalate the chemical species in the graphite 2. For example, the following method can be used: a vapor-phase method in which the graphite 2, which is a host, is contacted with a vapor of the chemical species at high temperature. Alternatively, the following method can be used: a liquid-phase method in which the chemical species is melted into a liquid at high temperature and the graphite 2, which is a host, is immersed in the liquid or in which the chemical species is dissolved in an organic solvent and the graphite 2 is immersed in the solution.

### EXAMPLES

The present disclosure is described below in detail with reference to examples. However, the present disclosure is not limited to the examples.

### Example 1

Graphite used was a PGS sheet, produced by Panasonic Corporation, having a size of 10 mm×10 mm×17 μm. A surface of the PGS sheet was irradiated with five pulses of a laser beam with a wavelength of 532 μm and a frequency of 60 kHz at a pulse width of 20 ns and a power of 1 W, whereby a through-hole with a diameter of 8 μm was formed so as to extend in a stacking direction of graphite. A plurality of holes (100×100 holes at center-to-center intervals of 100 μm) were formed in a similar manner, whereby 100 through-holes per unit area (1 mm²) were formed in the PGS sheet. The PGS sheet having the holes, 0.26 g of potassium chloride, and 0.6 g of copper (II) chloride anhydride were vacuum-sealed in an ampoule made of Pyrex glass (PYREX is a registered trademark). The ampoule was heat-treated at 400° C. for 100 hours. Potassium chloride and copper (II) chloride were removed from surfaces of the PGS sheet by water washing, whereby an electrically conductive material was obtained.

### Example 2

An electrically conductive material was obtained by substantially the same method as that used in Example 1 except that a surface of a PGS sheet was irradiated with 50 pulses of a laser beam with a wavelength of 1,060 μm and a frequency of 60 kHz at a pulse width of 30 ns and a power of 28 W such that through-holes with a diameter of 40 μm were formed.

### Example 3

An electrically conductive material was obtained by substantially the same method as that used in Example 1 except that a surface of a PGS sheet was irradiated with 10 pulses of a laser beam with a wavelength of 1,060 μm and a frequency of 60 kHz at a pulse width of 30 ns and a power of 28 W such that holes with a diameter of 40 μm were formed.

### Comparative Example 1

Graphite used was a PGS sheet, produced by Panasonic Corporation, having a size of 10 mm×10 mm×17 μm. The PGS sheet without holes, 0.26 g of potassium chloride, and 0.6 g of copper (II) chloride anhydride were vacuum-sealed in an ampoule (manufactured by Sekiya Rika Co., Ltd.) made of glass. The ampoule was heat-treated at 400° C. for 100 hours. Potassium chloride and copper (II) chloride were removed from surfaces of the PGS sheet by water washing, whereby an electrically conductive material was obtained.

### Comparative Example 2

A PGS sheet with a size of 10 mm×10 mm×17 μm was cut into pieces with an area of 1 mm² or less. The pieces were crushed, whereby graphite flakes were prepared. The graphite flakes, 0.26 g of potassium chloride, and 0.6 g of copper (II) chloride anhydride were vacuum-sealed in an ampoule made of Pyrex glass (PYREX is a registered trademark). The ampoule was heat-treated at 400° C. for 100 hours. Potassium chloride and copper (II) chloride were removed from surfaces of the graphite flakes by water washing. The resulting graphite flakes were charged into a compression pelletizer with a diameter of 10 mm and were pressed with a pressure of 100 MPa, whereby an electrically conductive material having a pellet-like shape was obtained.

### Measurement of Conductivity

The electrically conductive materials obtained in Examples 1 to 3 and Comparative Examples 1 and 2 were evaluated for electrical conductivity (a sample temperature of 200° C.) and thermal conductivity using Loresta-GP MCP-T610 (manufactured by Mitsubishi Chemical Corporation, LORESTA is a registered trademark) and Thermowave Analyzer 3 (manufactured by Bethel Co., Ltd.), respectively. The evaluation results are shown in Table.

TABLE

| | Electrical conductivity | Thermal conductivity |
|---|---|---|
| | (kS/cm) | (W/(m · K)) |
| Example 1 | 250 | 1,000 |
| Example 2 | 250 | 800 |
| Example 3 | 100 | 800 |
| Comparative Example 1 | 10 | 1,500 |
| Comparative Example 2 | 1 | 180 |

As shown in Table, the electrically conductive materials obtained in Examples 1 to 3 have an electrical conductivity larger than that of the electrically conductive materials obtained in Comparative Examples 1 and 2. For reference, a copper sheet has an electrical conductivity of 260 kS/cm and a thermal conductivity of 400 W/(m·K) and an aluminium copper sheet has an electrical conductivity of 210 kS/cm and a thermal conductivity of 200 W/(m·K). Therefore, the electrically conductive materials obtained in Examples 1 to 3 have an electrical conductivity equivalent to that of metal and a thermal conductivity superior to that of metal. The electrically conductive material obtained in Comparative Example 1 has a small electrical conductivity. This is probably because the electrically conductive material obtained in Comparative Example 1 has no holes and therefore a sufficient amount of a chemical species was not intercalated between layers in graphite. The electrically conductive material obtained in Comparative Example 2 has small grains due to the cutting and crushing of graphite and therefore has a small electrical conductivity and thermal conductivity.

An electrically conductive material according to the present disclosure can be used as a material with high heat dissipation and electrical conductivity. For example, in the case of using the electrically conductive material in various applications, such as semiconductors, solar cells, electric vehicles, and lighting systems, which use large power and require heat countermeasures, the electrically conductive material contributes to the enhancement of reliability and the downsizing of devices and therefore is useful.

What is claimed is:

1. An electrically conductive material comprising:
a graphite structure comprising graphene layers, the graphite structure having a first surface that is an outer surface of one of two outermost layers of the graphene layers, and a second surface that is an outer surface of the other of the two outermost layers of the graphene layers; and
a metal chloride located between the graphene layers, wherein
the graphite structure has holes on the first surface, the holes passing through at least one of the graphene layers toward the second surface, and
a number of the holes per unit area on the first surface is one or more per 1 mm².

2. The electrically conductive material according to claim 1, wherein the metal chloride includes at least one selected from a group consisting of iron chloride, copper chloride, nickel chloride, aluminium chloride, zinc chloride, cobalt chloride, gold chloride, and bismuth chloride.

3. The electrically conductive material according to claim 1, wherein the number of the holes per unit area on the first surface is one or more per 0.1 mm².

4. The electrically conductive material according to claim 3, wherein the number of the holes per unit area on the first surface is one or more per 0.01 mm².

5. The electrically conductive material according to claim 1, wherein at least one of the holes passes through the graphene layers from the first surface to the second surface.

6. The electrically conductive material according to claim 1, having an electrical conductivity of 100 kS/cm or more.

7. The electrically conductive material according to claim 1, having a thermal conductivity of 800 W/(m·K) or more.

8. The electrically conductive material according to claim 1, wherein the total area of the holes per unit area on the first surface is 0.1 cm² or less per 1 cm².

9. The electrically conductive material according to claim 1, wherein the holes each have a diameter of 1 nm or more and 500 μm or less.
